(19) United States
(12) Patent Application Publication
(10) Pub. No.: US 2007/0055767 A1
(43) Pub. Date: Mar. 8, 2007

(54) Networked helpdesk and call center support for configuration and support of electronics and appliances

(75) Inventor: Amber Eileen Victor, Chula Vista, CA (US)

Correspondence Address: Amber Victor, 349 Corte Trova, Chula Vista, CA, 91914, US

(73) Assignee: Amber Eileen Victor, Chula Vista, CA (US)

(21) Appl. No.: 11/162,202

(22) Filed: Aug. 31, 2005

(51) Int. Cl. G06F 15/173; G06F 15/16

(52) U.S. Cl. 709/224; 709/219

(57) ABSTRACT

Using available network connectivity, data with information about the consumers' electronic device or appliance would be transferred to a central server(s). A call center, support staff, automated server solution or helpdesk would have the capability to remotely control and program electronic devices via a networked connection for subscribing consumers and their electronic devices and appliances. Consumers would no longer need to be knowledgeable about their electronic devices and could rely on the helpdesk or call center to program, troubleshoot and answer questions about said devices. For example: The consumer could request that their VCR be programmed for them or even set their refrigerator to the desired temperature, the service would connect to the devices and complete the requested tasks remotely. The service would be able to remotely query the device hardware for available error codes and either upload a firmware fix or dispatch the appropriate repair service.

The consumer would have access to both a call center and online help in order to program their electronics and appliances. Using available IP protocols or other forms of network connectivity, data with information about the consumers' electronic device or appliance would be transferred to a central server(s). Helpdesk, support, automated solutions or call center staff would use this information and either an integrated device embedded into the electronic device or appliance or external connectivity box to gather information about the state, capabilities and status of the electronic device or appliance.

The call center or helpdesk would have the capability to fully control the electronic device remotely via the networked connection to the device. Consumers would no longer need to be knowledgeable about their own electronic devices and could rely on the helpdesk or call center to program, troubleshoot and answer questions about said devices. Some examples would be programming ones VCR to record a show at 7 pm. The consumer could call the center, post a request online or send an email requesting that their VCR be programmed for them or even set their refrigerator to the desired temperature. If an electronic device or appliance were not operating properly the helpdesk would be able to query the device for available error codes and either upload a firmware fix or dispatch the appropriate repair service.

What is claimed is:

1. A method of connecting using any network protocol or Internet service, an electronic device or appliance to a central server to download and/or upload information pertaining to the device.

2. The method of claim 1 can be achieved through either embedded device hardware subject to agreement between holder(s) of this patent or external device subject to agreement between holder(s) of this patent.

3. A method to use the information to program, service and support electronic devices and appliances.

4. A method to establish communication between a consumer and support personnel.

5. The method of claim 4 consist any available form of communication such as telephone, web, VPN, Internet based, email, or other available networking protocol.
